(19) United States
(12) Patent Application Publication
(10) Pub. No.: US 2011/0279787 A1
(43) Pub. Date: Nov. 17, 2011

(54) PROJECTION DISPLAY DEVICE

(75) Inventors: Taichi Yoshimura, Osaka-city (JP); Toshimasa Kanbara, Kishiwada-city (JP); Jaehyun Lee, Daito-city (JP)

(73) Assignee: SANYO ELECTRIC CO., LTD., Moriguchi-city (JP)

(21) Appl. No.: 13/102,184

(22) Filed: May 6, 2011

(30) Foreign Application Priority Data
May 13, 2010 (JP) 2010-111113

(51) Int. Cl. G03B 21/16; G03B 21/28

(52) U.S. Cl. 353/57; 353/98

(57) ABSTRACT

A projection display device includes an imager portion which is arranged in a position closer to one side surface of a main body cabinet to modulate light and guide the light in a direction away from the side surface, and a projection portion. The projection portion is formed by a projection lens portion and a mirror portion which reflects the light through the projection lens portion toward a projection plane. The mirror portion is disposed so as to be shifted from an optical axis of the projection lens portion in a direction opposite to a direction in which the light from the projection lens portion is turned back. A control circuit portion and a holding member are disposed within a space produced between the projection lens portion and the main body cabinet due to a position gap between the projection lens portion and the mirror portion.

This application claims priority under 35 U.S.C. Section 119 of Japanese Patent Application No. 2010-111113 filed May 13, 2010, entitled “PROJECTION DISPLAY DEVICE”. The disclosure of the above application is incorporated herein by reference.

### BACKGROUND OF THE INVENTION

1. Field of the Invention

The present invention relates to a projection display device that modulates light from a light source by an imager, and enlarges and projects the modulated light on a projection plane. The present invention relates particularly to a projection display device that forms an image on an imager as an intermediate image between a projection lens and a mirror, and enlarges and projects the intermediate image by the mirror.

2. Disclosure of Related Art

Conventionally, in a projection display device such as a liquid crystal projector (hereinafter, called “projector”), expanding a projection angle of light from a projection optical system has been promoted for shortening a distance between a screen and the projector. In addition to expanding the projection angle, there is proposed a projector configured to perform slant projection such that projection light emitted from the projector is obliquely projected onto a screen.

In the thus configured projector, a projection lens unit and a reflection mirror can be used as a projection optical system, for example. In this configuration, an image on an imager is formed as an intermediate image between the projection lens unit and the reflection mirror, and the intermediate image is enlarged and projected by the reflection mirror. This realizes a shorter projection distance.

The foregoing projector can be installed in various forms. For example, the projector body can be installed on an installation plane such as a desk, a floor, or the like (so-called stationary installation) or can be installed upside down on a ceiling (so-called suspension installation). In these installation forms, an image is projected onto a projection plane (screen or the like) vertical to the installation plane or the ceiling.

Besides, the foregoing projector can be installed in such a manner that the projector body is installed in portrait orientation so as to stand on the installation plane (hereinafter, this installation form will be referred to as “portrait-oriented installation”). In the case of portrait-oriented installation, the reflection mirror is positioned above the projector body, and an image is projected onto the installation plane itself through reflection by the reflection mirror.

In the projector, the reflection mirror is disposed so as to be shifted from an optical axis of the projection lens unit in a direction opposite to a direction in which incident light from the projection lens unit is turned back. Accordingly, the projector body has the reflection mirror protruded from an outer surface thereof toward an outer surface of the projection lens unit in a direction in which the reflection mirror is shifted (hereinafter, referred to “shift direction”). In addition, the projector has the reflection mirror relatively heavy in weight.

Therefore, when the projector is installed in portrait orientation, the position of a gravity center is largely moved in the shift direction toward a side of the reflection mirror and becomes higher in an up-down direction, whereby the projector body is prone to fall down in the shift direction. Accordingly, for supporting the projector in a stable manner, a dedicated stand is attached to the projector body.

However, at portrait-oriented installation of the projector, it is desired to save users for having to perform troublesome tasks as much as possible, such as attaching a dedicated stand.

### SUMMARY OF THE INVENTION

A projection display device in a main aspect of the present invention includes a main body cabinet, an imager portion which is arranged in a position closer to one side surface of the main body cabinet to modulate light from a light source and guide the light in a direction away from the side surface, and a projection portion which enlarges and projects the light modulated by the imager portion. In this arrangement, the projection portion is formed by a projection lens portion into which the light from the imager portion is entered and a mirror portion which reflects the light having passed through the projection lens portion and lets the light travel toward a projection plane. The mirror portion is disposed so as to be shifted from an optical axis of the projection lens portion in a direction opposite to a direction in which the incident light from the projection lens portion is turned back. Further, a control circuit portion and a metallic holding member are disposed within a space produced between the projection lens portion and the main body cabinet due to a position gap between the projection lens portion and the mirror portion, the holding member holding the control circuit portion therewithin while supporting the imager portion and the projection portion with respect to the main body cabinet.

### BRIEF DESCRIPTION OF THE DRAWINGS

The foregoing and other objects and novel features of the present invention will be more fully understood from the following description of a preferred embodiment when reference is made to the accompanying drawings.

FIGS. 1A and 1B are diagrams (perspective views) showing an outer configuration of a projector in an embodiment of the present invention.

FIG. 2 is a diagram (bottom view) showing an outer configuration of the projector in the embodiment.

FIG. 3 is a diagram showing an inner structure of the projector in the embodiment.

FIG. 4 is a diagram showing schematically a configuration of the projection optical unit in the embodiment.

FIGS. 5A and 5B are diagrams showing a configuration of a control circuit unit in the embodiment.

FIG. 6 is a diagram of a configuration of the control circuit unit in the embodiment.

FIG. 7 is a diagram showing a configuration of the control circuit unit in the embodiment.

FIG. 8 is a diagram showing a configuration of an optical unit in the embodiment.

FIG. 9 is a diagram showing the main body cabinet with the optical unit not yet attached in the embodiment.

FIGS. 10A and 10B are diagrams showing the projector installed in portrait orientation in the embodiment.

However, the drawings are only for illustration and do not limit the scope of the present invention.

### DESCRIPTION OF PREFERRED EMBODIMENTS

In the following, an embodiment of the invention is described referring to the drawings.

In this embodiment, a lamp unit 14 is equivalent to a “light source” recited in the claims; an imager unit 15 is equivalent to an “imager portion” recited in the claims; a projection optical unit 17 is equivalent to a “projection portion” recited in the claims; a projection lens unit 101 is equivalent to a “projection lens portion” recited in the claims; a reflection mirror 102 is equivalent to a “mirror portion” recited in the claims; a main control board 210 and an extension interface board 220 are equivalent to a “circuit board” recited in the claims; a terminal panel 240 is equivalent to a “terminal portion” recited in the claims; a holder 250 is equivalent to a “holding member” recited in the claims. The foregoing correspondence in description between the claims and this embodiment are merely examples, and do not limit the claims to this embodiment.

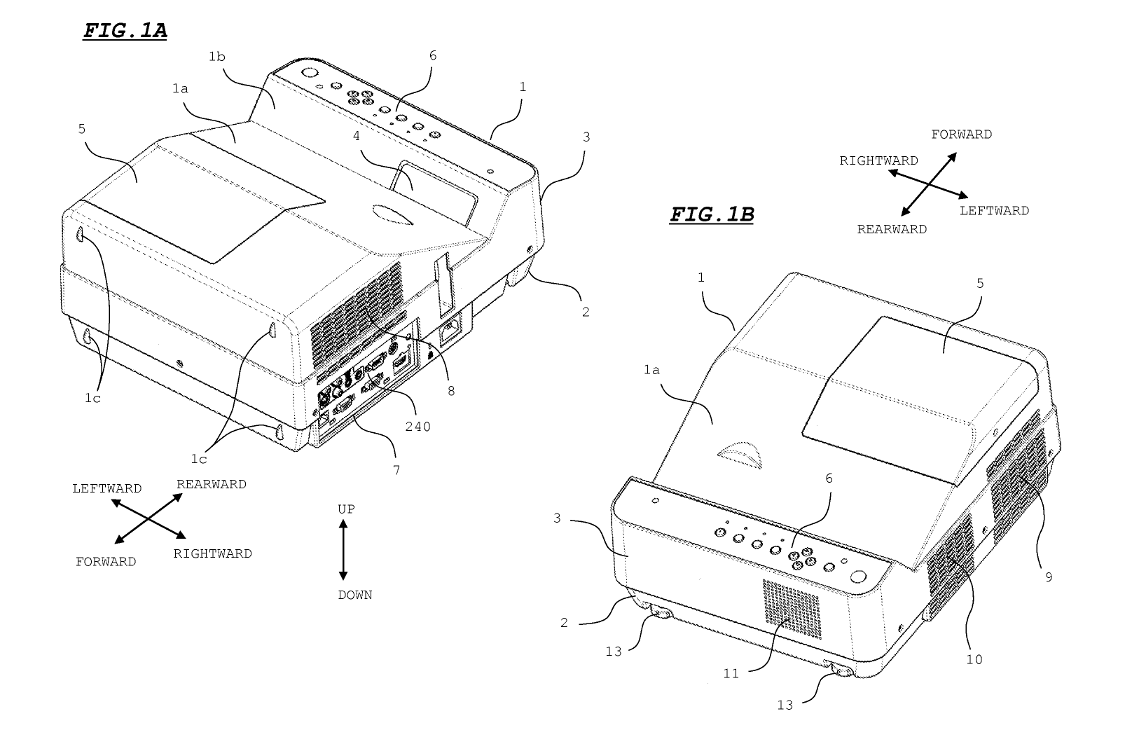

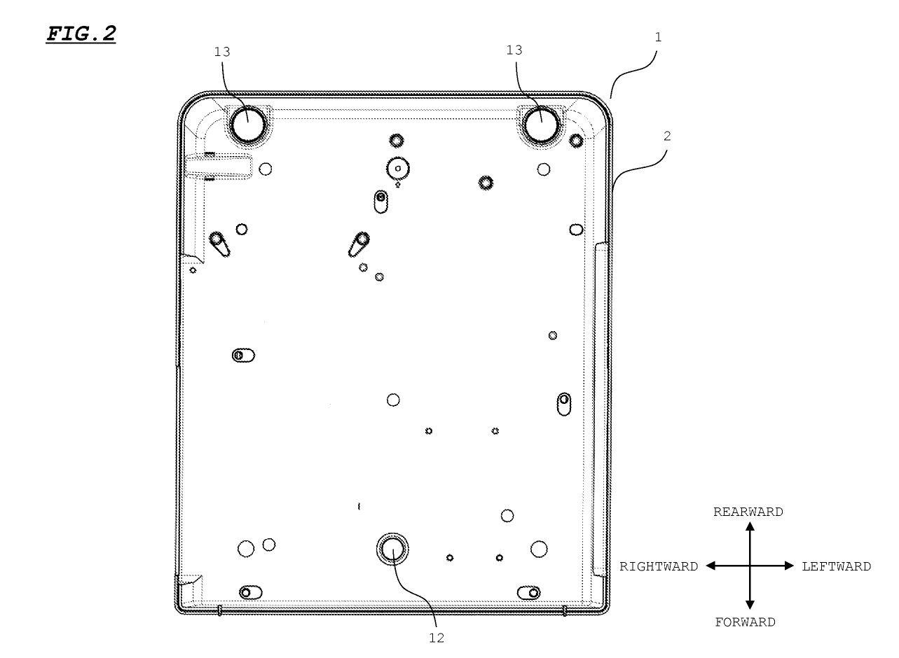

FIGS. 1A, 1B and FIG. 2 are diagrams showing an external construction of a projector embodying the invention. FIG. 1A is a perspective view of the projector when viewed from a front side, and FIG. 1B is a perspective view of the projector when viewed from a rear side. FIG. 2 is a bottom view of the projector. To simplify the description, arrows respectively indicating forward, rearward, leftward, and rightward directions are depicted in FIGS. 1A, 1B and FIG. 2. Hereinafter, the arrows indicating forward, rearward, leftward, and rightward directions are depicted in the same manner as above in the other drawings, as necessary.

The projector of the embodiment is a so-called short focus projector. Referring to FIGS. 1A and 1B, the projector is provided with a main body cabinet 1 having a substantially rectangular parallelepiped shape. The main body cabinet 1 is constituted of a lower cabinet 2, and an upper cabinet 3 which is placed on the lower cabinet 2 from above.

A top surface of the main body cabinet 1 is formed with a first slope 1a inclined downward and rearward, and a second slope 1b continuing from the first slope 1a and inclined upward and rearward. The second slope 1b faces obliquely upward and forward, and a projection port 4 is formed in the second slope 1b. Image light emitted obliquely upward and forward through the projection port 4 is enlarged and projected onto a screen disposed in front of the projector.

Further, the top surface of the main body cabinet 1 is formed with a lamp cover 5. The top surface of the main body cabinet 1 is formed with a lamp opening for use in exchanging a lamp unit, and a filter opening for use in exchanging a filter disposed in a fan unit for cooling the lamp unit. The lamp cover 5 is a cover for covering the lamp opening and the filter opening. Further, the top surface of the main body cabinet 1 is provided with an operation portion 6 constituted of a plurality of operation keys.

A terminal port portion 7 is formed in a right surface of the main body cabinet 1. A terminal panel 240 having various terminals such as AV terminals is attached to the terminal port portion 7. The terminal panel 240 constitutes a part of a control circuit unit to be described later. Audio Visual (AV) signals such as an image signal and an audio signal are inputted and outputted to and from the projector through the AV terminals. Further, an air inlet 8 is formed in the right surface of the main body cabinet 1 at a position above the terminal port portion 7. The air inlet 8 is constituted of multitudes of slit holes, and external air is drawn into the main body cabinet 1 through the air inlet 8.

A first air outlet 9 and a second air outlet 10 are formed in a left surface of the main body cabinet 1. Each of the first and second air outlets 9, 10 is constituted of multitudes of slit holes, and air inside the main body cabinet 1 is discharged to the outside of the projector through the first and second air outlets 9, 10. Further, a sound output port 11 is formed in a rear surface of the main body cabinet 1. Sounds in accordance with images are outputted through the sound output port 11 at the time of image projection.

Referring to FIG. 2, a fixed leg 12 is disposed in the middle of a front portion on a bottom surface of the main body cabinet 1, and two adjustable legs 13 are disposed at a rear end thereof. By expanding or contracting the two adjustable legs 13 up and down, it is possible to adjust the inclination of the main body cabinet 1 in forward/rearward directions and leftward/rightward directions. Thus, it is possible to adjust the upward/downward position and the leftward/rightward inclination of an image projected on a screen.

The projector of the embodiment may be installed in a suspended state from a ceiling with the main body cabinet 1 being upside down, other than an installation manner that the bottom surface of the main body cabinet 1 is placed on an installation plane such as a desk surface or a floor surface.

Further, the projector of this embodiment allows portrait-oriented installation in which a front surface of the main body cabinet 1 is placed on the installation plane. In the case of the portrait-oriented installation, an image is projected onto the installation plane itself. For enabling the portrait-oriented installation, the front surface of the main body cabinet 1 is made almost flat, and does not have the terminal panel 240 or the air inlet 8 on the front surface but has four leg portions 1c for contact with the installation plane at portrait-oriented installation.

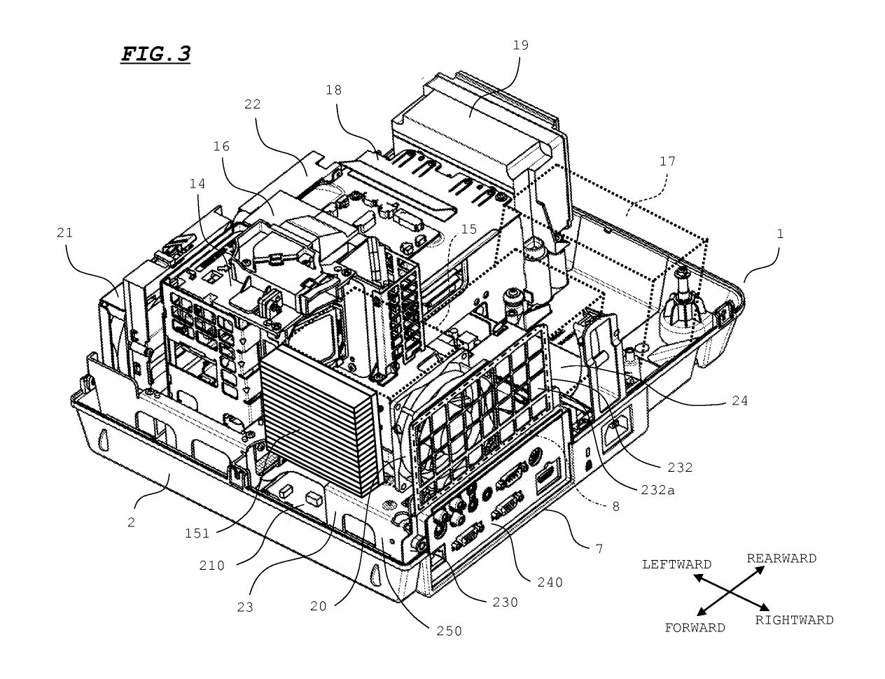

FIG. 3 is a diagram showing an internal structure of the projector. FIG. 3 is a perspective view showing a state that the upper cabinet 3 is detached, when viewed from a front side. To simplify the description, in FIG. 3, an imager unit 15 and a projection optical unit 17 are indicated by the dotted lines. Further, the position of the air inlet 8 is indicated by the one-dotted chain line.

Referring to FIG. 3, a lamp unit 14, and the imager unit 15 for modulating light from the lamp unit 14 to generate image light are disposed on a front portion of the lower cabinet 2.

The lamp unit 14 is constituted of a light source lamp, and a lamp holder for holding the light source lamp; and is configured so as to be detachably attached from above. A fan unit 16 is disposed behind the lamp unit 14. The fan unit 16 supplies external air (cooling air) drawn through the air inlet 8 to the light source lamp to cool the light source lamp. The lamp holder is formed with an air duct for guiding the cooling air from the fan unit 16 to the light source lamp.

The imager unit 15 includes a color wheel and a Digital Micromirror Device (DMD). The color wheel separates white light from the light source lamp into light of respective colors such as red, green, blue in a time-sharing manner. The DMD modulates the light of the respective colors emitted from the color wheel based on an image signal.

The imager unit 15 further includes a heat sink 151 made of a heat-conducive metallic material. The heat sink 151 is sized so as to cover the almost entire front surface of the imager unit 15, and is disposed on the front side of the imager unit 15, that is, near the front surface of the main body cabinet 1. The heat sink 151 is coupled to the DMD via a thermal conducting member (not shown).

The projection optical unit 17 is disposed at a rear position of the imager unit 15. The projection optical unit 17 enlarges image light generated by the imager unit 15, and projects the enlarged image light onto a projection plane such as a screen.

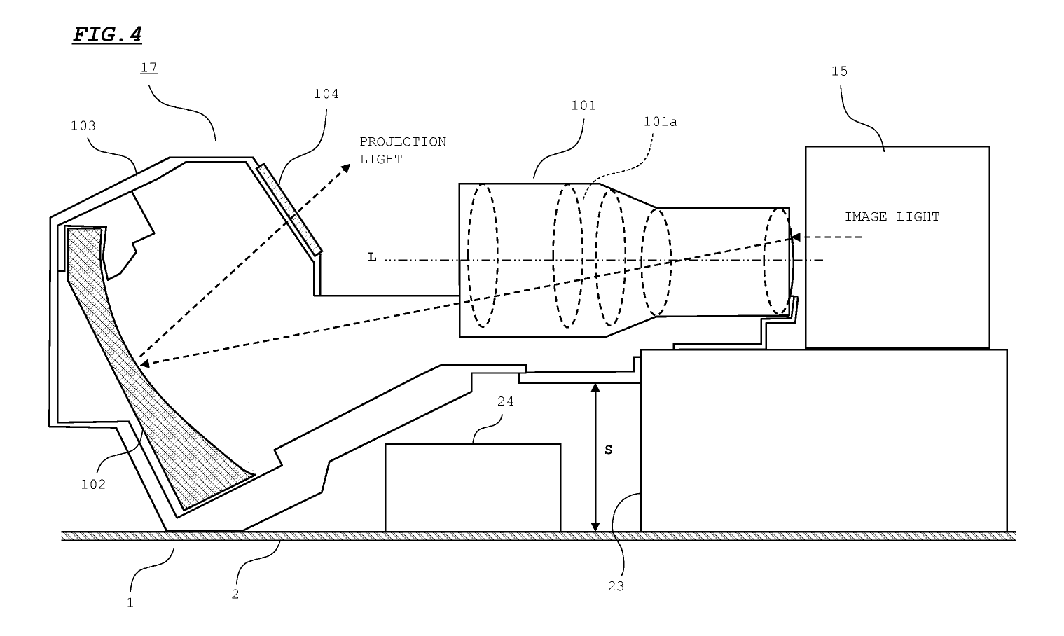

FIG. 4 is a diagram schematically showing an arrangement of the projection optical unit 17. In FIG. 4, the imager unit 15, a control circuit unit 23, and a noise filter unit 24 are schematically shown, in addition to the projection optical unit 17.

The projection optical unit 17 is constituted of a projection lens unit 101, a reflection mirror 102, and a housing 103 for housing the projection lens unit 101 and the reflection mirror 102. The projection lens unit 101 has a plurality of lenses 101a. The reflection mirror 102 is a curved mirror or a free curved mirror.

As shown in FIG. 4, image light emitted from the imager unit 15 is entered into the projection lens unit 101 at a position shifted from the optical axis L of the projection lens unit 101 in a direction toward the top surface of the main body cabinet 1. The entered image light receives a lens function by the projection lens unit 101, and is entered into the reflection mirror 102. Thereafter, the projection angle of the image light is expanded by the reflection mirror 102, and the image light is projected onto a projection plane (screen) via a light ray passage window 104.

As described above, image light is entered into the projection lens unit 101 at a position shifted from the optical axis L of the projection lens unit 101 in a direction toward the top surface of the main body cabinet 1. In view of this, the reflection mirror 102 is disposed at a position shifted from the optical axis L of the projection lens unit 101 toward the bottom surface of the main body cabinet 1. Here, the reflection mirror 102 has a reflection surface larger than the lens surface of each lens 101a constituting the projection lens unit 101. Accordingly, the shift amount of the reflection mirror 102 with respect to the optical axis L of the projection lens unit 101 is relatively large. Consequently, there is defined a relatively large space G between a lower surface of the projection lens unit 101 and the bottom surface of the main body cabinet 1 (lower cabinet 2). The space G is defined from the position where the projection lens unit 101 is disposed to the position where the imager unit 15 is disposed.

Referring back to FIG. 3, a power source unit 18 is disposed behind the fan unit 16. The power source unit 18 is provided with a power source circuit to supply electric power to each electric component of the projector. A speaker 19 is disposed behind the power source unit 18. Sounds outputted through the speaker 19 are released to the outside through the sound output port 11.

A DMD cooling fan 20 is disposed on the right of the imager 15. The DMD cooling fan 20 supplies external air taken in from the air inlet 8 to the heat sink 151. Heat emitted from the DMD is transferred to the heat sink 151 and then is discharged from the heat sink 151. This allows the DMD to be cooled down.

A lamp exhaust fan 21 is disposed on the left of the lamp unit 14. The lamp exhaust fan 21 draws the air that has cooled the light source lamp, and discharges the air to the outside through the first air outlet 9.

A power source exhaust fan 22 is disposed on the left of the power source unit 18. The power source exhaust fan 22 draws warmed air inside of the power source unit 18, and discharges the warmed air to the outside through the second air outlet 10. By flowing the air from the inside of the power source unit 18 to the power source exhaust fan 22, fresh external air is supplied into the power source unit 18 through the air inlet 8.

As shown in FIG. 3 and FIG. 4, in the projector of the embodiment, the control circuit unit 23 and the noise filter unit 24 are disposed in the space G defined below the projection lens unit 101 and the imager unit 15.

The noise filter unit 24 is provided with a circuit board mounted with a noise filter and a fuse thereon, and supplies electric power inputted from a commercial AC power source to the power source unit 18 after noise removal.

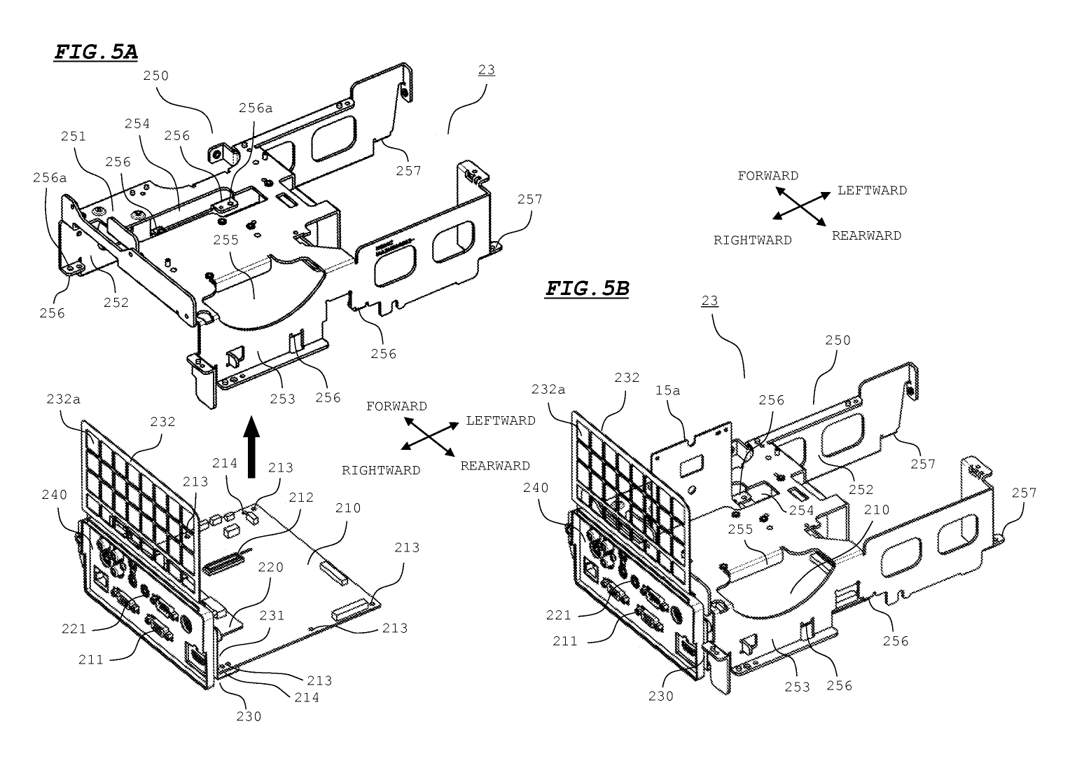

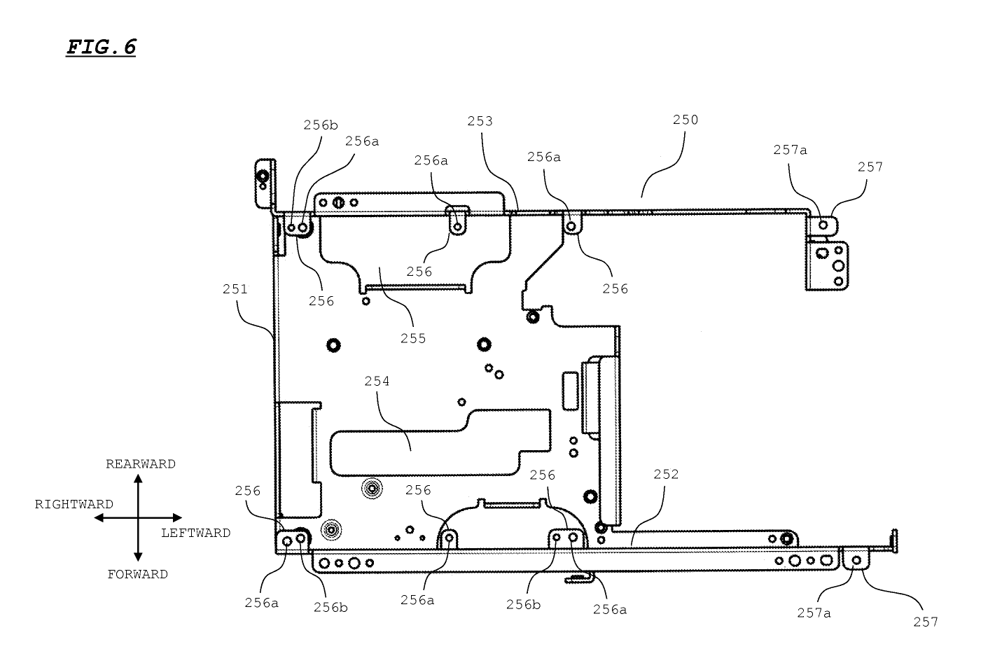

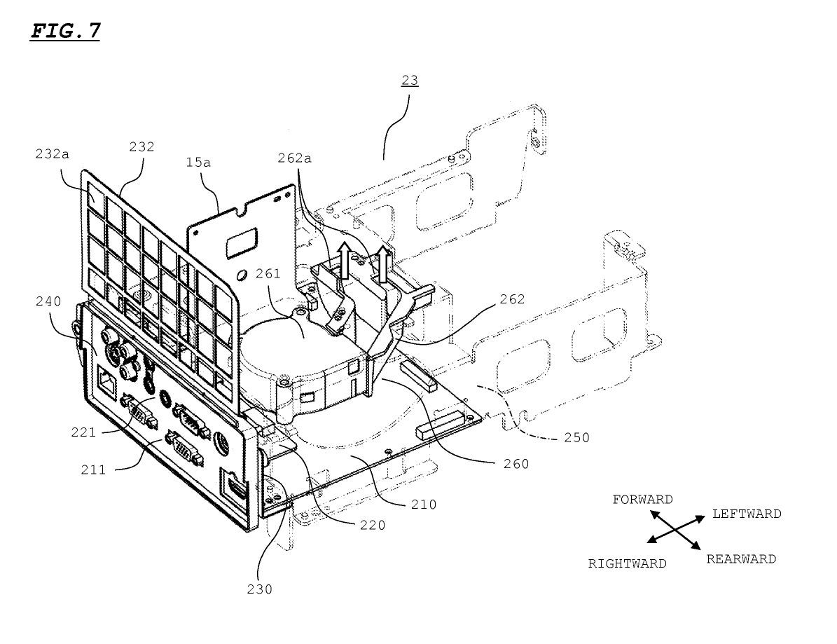

FIGS. 5A to 7 are diagrams showing a configuration of the control circuit unit 23. FIG. 5A is a perspective view of the control circuit unit 23 in which the main control board 210 and the extension interface board 220 are not yet built into the holder 250. FIG. 5B is a perspective view of the control circuit unit 23 in which the main control board 210 and the extension interface board 220 are built into the holder 250. FIG. 6 is a plan view of the holder 250 as seen from underneath. FIG. 7 is a perspective view of the main control board 210 and the extension interface board 220 that are built into the holder 250, in which the color wheel cooling unit 260 can be seen through the interior of the holder 250. FIG. 7 shows the holder 250 by a chain double-dashed line.

Referring to FIGS. 5A to 7, the control circuit unit 23 is formed by the main control board 210, the extension interface board 220, a fixing board 230, a terminal panel 240, the holder 250 and the color wheel cooling unit 260.

The main control board 210 has a control circuit for controlling various drive parts such as a light source lamp, a DMD, and the like. In addition, the main control board 210 has at a right end thereof various terminals 211 and has at a center thereof a connector 212 for connection with a DMD wiring board 15a.

The main control board 210 has total six attachment holes 213 formed at four corners, between two front corners, and between two back corners. In addition, the main control board 210 has positioning holes 214 formed next to the attachment holes 213 at the three corners other than the left and back corners. In FIG. 5A, the attachment holes 213 and the positioning holes 214 at the right and front corners are hidden by the terminal panel 240.

The extension interface board 220 has terminals 221 other than the terminals disposed on the main control board 210.

The fixing board 230 is made of a metallic material, and has the fixing portion 231 and the shielding portion 232 vertically integrated. The fixing portion 231 has one surface on which the interface board 220 and the main control board 210 are vertically aligned and fixed, and has the other surface on which the terminal panel 240 is fixed. The shielding portion 232 has a large number of openings 232a with metallic meshes (not shown). As shown in FIG. 3, when the control circuit unit 23 is attached to the main body cabinet 1, the shielding portion 232 is disposed on an inner side of the air inlet 8. External air taken in by the air inlet 8 flows into the main body cabinet 1 through the openings 232a. The shielding portion 232 blocks out electromagnetic waves that are about to leak outward from the air inlet 8.

The terminal panel 240 has openings shaped to be suitable for the terminals 211 and 221. The terminals 211 and 221 are exposed from these openings. Although not shown, the fixing portion 231 of the fixing board 230 has also openings through which the terminals 211 and 221 pass.

The holder 250 is made of a metallic material (for example, aluminum), and has an upper plate 251, and a front plate 252 and a back plate 253 on front and back sides of the upper plate 251, respectively.

The upper plate 251 has an opening 254 through which the DMD wiring board 15a passes and an opening 255 for storing the bottom portion of the projection optical unit 17 at an incident end side. As shown in FIG. 6, the front plate 252 and the back plate 253 have six attachment pieces 256 corresponding to the six attachment holes 213 of the main control board 210. The attachment pieces 256 have respective attachment holes 256a. In addition, the two attachment pieces 256 of the front plate 252 on the both sides and the attachment piece 256 of the back plate 253 at a right end have respective positioning projections 256b corresponding to the positioning holes 214 of the main control board 210.

Further, the front plate 252 and the back plate 253 have at left ends respective attachment pieces 257 for attaching the holder 250 to the main body cabinet 1. These attachment pieces 257 have also attachment holes 257a.

As shown in FIG. 5A, the main control board 210 and the extension interface board 220 are stored from underneath in a storage space surrounded by the upper plate 251, the front plate 252, and the back plate 253. When stored in place within the storage space, the main control board 210 contacts the six attachment pieces 256 from underneath, and the three positioning holes 214 of the main control board 210 fit onto the corresponding positioning projections 256b of the attachment pieces 256. Accordingly, the six attachment holes 213 of the main control board 210 are aligned with the corresponding attachment holes 256a of the attachment pieces 256. Among the six attachment holes 213 of the main control board 210, the two central attachment holes 213 and the corresponding attachment pieces 256 are fastened to each other by screws. Accordingly, as shown in FIG. 5B, the main control board 210 and the extension interface board 220 are fixed to the holder 250, whereby the control circuit unit 23 is completely assembled. At this point of time, the attachment holes 213 of the main control board 210 at the four corners and the corresponding attachment pieces 256 are not fastened to each other by screws.

When the imager unit 15 (not shown in FIG. 5B) is attached to the top surface of the holder 250, the DMD wiring board 15a connected to the DMD is inserted through the opening 254 into the storage space of the holder 250 as shown in FIG. 5B. Then, a connector (not shown) formed on the DMD wiring board 15a is connected to the connector 212 on the main control board 210. The DMD wiring board 15a has a signal line for the DMD through which drive signals from the DMD driver on the main control board 210 are transmitted to the DMD.

In addition, the main control board 210 may discharge electromagnetic waves during operation, but the holder 250 made of a metallic material can block out such electromagnetic waves.

The color wheel cooling unit 260 is built into the holder 250 before the main control board 210 and the extension interface unit 220 is built into the holder 250. As shown in FIG. 7, the color wheel cooling unit 260 is formed by a cooling fan 261 as a centrifugal fan and a fan duct 262 connected to the cooling fan 261. The cooling fan 261 and the fan duct 262 are both attached to a back surface of the upper plate 251 of the holder 250. When the fan duct 262 is attached to the upper plate 251, two blowoff outlets 262a are formed at a leading end of the fan duct 262. A color wheel on the light source unit 15 is positioned above these blowoff outlets 262a. Cooling air from the cooling fan 261 passes through the fan duct 262 and blows off through the blowoff outlets 262a toward the color wheel positioned above. This allows the color wheel to be cooled down.

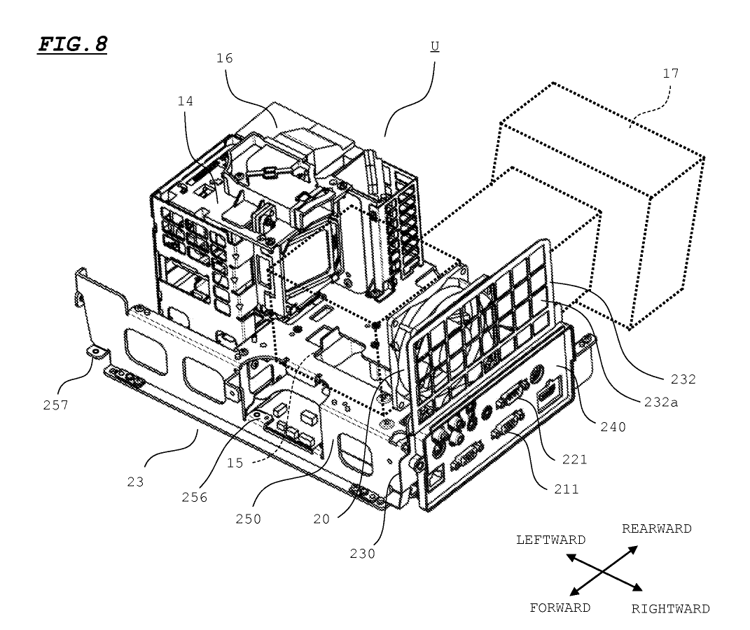

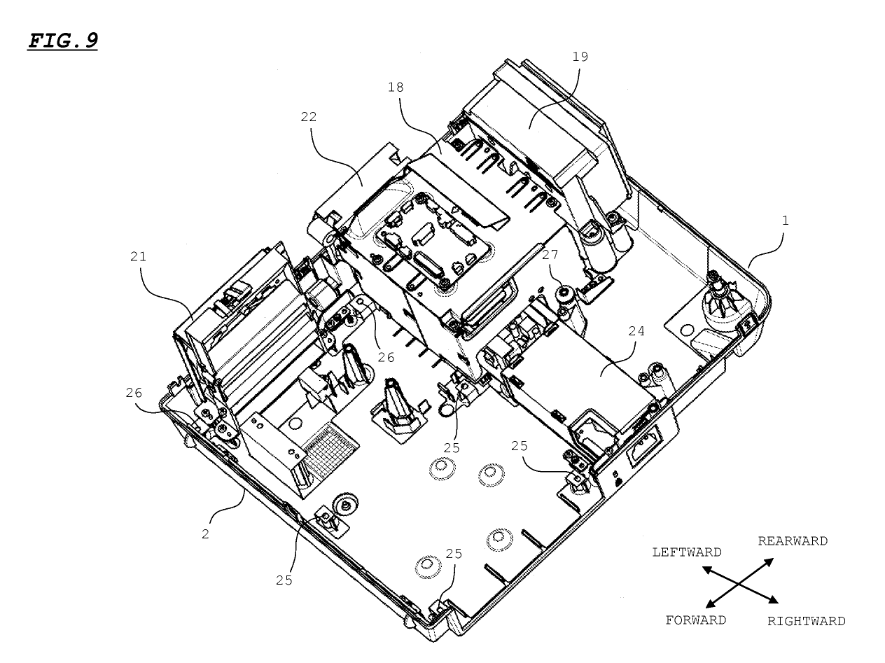

FIG. 8 is a diagram showing a configuration of the optical unit U. FIG. 9 is a diagram showing the main body cabinet 1 with the optical unit U not yet attached.

As shown in FIG. 8, the lamp unit 14, the imager unit 15, the projection optical unit 17, the fan unit 16, and the DMD cooling fan 20 are fixed to the holder 250 of the control circuit unit 23, by an appropriate fixing method such as screwing or the like. Accordingly, the control circuit unit 23, the lamp unit 14, the imager unit 15, the projection optical unit 17, the fan unit 16, and the DMD cooling fan 20 are integrated into one optical unit U.

As shown in FIG. 9, for fixation of the optical unit U, the lower cabinet 2 is provided with four attachment portions 25 corresponding to the four attachment pieces 256 of the holder 250 not yet screwed at incorporation of the main control board 210, two attachment portions 26 corresponding to the two attachment pieces 257 at the left end of the holder 250, and one attachment portion 27 corresponding to an attachment piece (not shown) provided on the housing 103 of the projection optical unit 17.

The optical unit U is fixed to the bottom surface of the lower cabinet 2 (main body cabinet 1) as shown in FIG. 3, the seven attachment pieces 256 and 257 by screws to the corresponding seven attachment portions 25, 26, and 27 by fastening. As described above, the attachment holes 213 of the main control board 210 are aligned with the attachment holes 256a of the four attachment pieces 256. Therefore, the main control board 210 is fastened together with the attachment pieces 256 to the attachment portions 25 by screws. Accordingly, the main control board 210 is firmly fixed by screws at the total six points to the holder 250.

When the optical unit U is fixed to the bottom surface of the main body cabinet 1, the imager unit 15 and the projection optical unit 17 are supported by the holder 250 with respect to the bottom surface of the main body cabinet 1.

If the main control board 210 is broken, the main control board 210 needs to be removed from the holder 250 for repair or replacement with a new main control board 210. In this case, an engineer (service person) unscrews the seven screws fixing the optical unit U and removes the optical unit U from the main body cabinet 1. After that, he/she unscrews the two screws to remove the main control board 210 from the holder 250.

Accordingly, this embodiment eliminates the need to follow a troublesome procedure: firstly removing the imager unit 15 and the projection optical unit 17 above the control circuit unit 23 from the main body cabinet 1; and then removing the control circuit unit 23 from the main body cabinet 1. This facilitates replacement of the main control board 210.

In the projector of this embodiment, it is possible to project an image onto an installation plane itself such as a desk or a floor or the like by installing the projector in portrait orientation as described above.

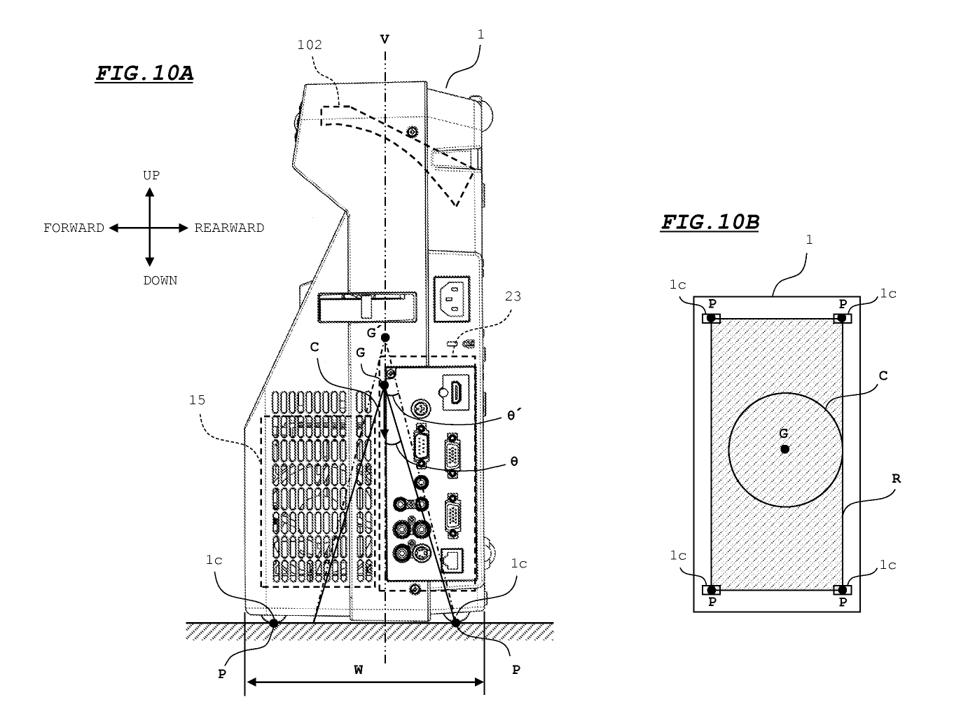

FIGS. 10A and 10B are diagrams showing the projector installed in portrait orientation. FIG. 10A is a view of the projector as seen from the right side surface, and FIG. 10B is a schematic view of the projector as seen from the installation plane.

In this embodiment, the control circuit unit 23 is disposed in a space S produced between the projection lens unit 101 and the bottom surface of the main body cabinet 1 due to a position gap between the projection lens unit 101 and the reflection mirror 102. Accordingly, it is possible to increase a width W of the reflection mirror 102 in the shift direction (front-back direction shown in FIG. 10A) on the projector body on a side opposite to a side on which the reflection mirror 102 is disposed, that is, at a lower portion of the projector body installed in portrait orientation, as shown in FIG. 10A.

In addition, the control circuit unit 23 includes the metallic holder 250, the main control board 210 disposed within the holder 250, the extension interface board 220, and the color wheel cooling unit 260, which makes the control circuit unit 23 relatively heavy in weight. In addition, the imager unit 15 is provided with the heat sink 151, which also makes the imager unit 15 relatively heavy in weight. Accordingly, in this embodiment, the lower portion of the projector can be made heavier in weight at portrait-oriented installation. This makes it possible to situate a gravity center G in a lower position in the up-down direction even if the relatively heavy-weight reflection mirror 102 is disposed above the projector body, as shown in FIG. 10A.

As shown in FIGS. 10A and 10B, a right circular cone C with the gravity center G as an apex is drawn between the gravity center G and the installation plane. The right circular cone C is defined as a largest right circular cone in which a bottom surface thereof does not go beyond a region R surrounded by support points P of the four leg portions 1c, as shown in FIG. 10B. Even if the projector is inclined in any direction, the gravity center G does not deviate from the region R, provided that an angle of the inclination falls within an angle θ formed by a vertical line V passing through the gravity center G and a cone plane of the right circular cone C (hereinafter, referred to as “allowable inclination angle θ”) as shown in FIG. 10A. Accordingly, the projector does not fall down.

In this embodiment, it is possible to increase the width W and lower the position of the gravity center G in the up-down direction, thereby making the allowable inclination angle θ larger. Accordingly, the projector can be stably installed in portrait orientation without using any dedicated stand or the like.

If the position of a gravity center G′ is raised in the up-down direction as shown in FIG. 10A, an allowable inclination angle θ′ becomes smaller and thus the projector is prone to fall down when being inclined. In addition, if the control circuit unit 23 is not disposed in the space S between the projection lens unit 101 and the bottom surface of the main body cabinet 1, since the width W becomes shorter, the allowable inclination angle θ becomes smaller and thus the projector is prone to fall down when being inclined.

Although an embodiment of the present invention is as described above, the present invention is not limited to this embodiment. In addition, the embodiment of the present invention can be appropriately modified in various manners within the scope of technical ideas shown in the claims.

For example, in the foregoing embodiment, the imager unit 15 is provided with the heat sink 151 so that the DMD can be cooled down by the heat sink 151. However, the imager unit 15 may not necessarily be provided with the heat sink 151 but may be configured to supply air directly to the DMD. As a matter of course, providing the imager unit 15 with the heat sink 151 makes it possible to further lower the position of the gravity center G in the up-down direction when the projector is installed in portrait orientation. Accordingly, the arrangement in the foregoing embodiment is more desirable.

In addition, in the foregoing embodiment, the color wheel cooling unit 260 is arranged within the holder 250. However, the color wheel cooling unit 260 may not necessarily be arranged within the holder 250. As a matter of course, arranging the color wheel cooling unit 260 within the holder 250 makes it possible to further lower the position of the gravity center G in the up-down direction when the projector is installed in portrait orientation. Accordingly, the arrangement in the foregoing embodiment is more desirable.

Further, in the foregoing embodiment, the DMD is used as an imager constituting the imager unit 15. Alternatively, a liquid crystal panel may be used instead.

In addition, in the foregoing embodiment, the lamp unit 14 having a light source lamp is used. Alternatively, any light source other than a lamp light source, for example, a laser light source or an LED light source may be used instead.

Further, in the foregoing embodiment, the holder 250 holds the extension interface board 220 together with the main control board 210. Alternatively, in addition to the extension interface board 220 or instead of the extension interface board 220, the holder 250 may hold any other circuit board, for example, a communication circuit board, together with the main control board 210. Such a communication circuit board has a communication circuit for performing communications between the projector and another device such as a personal computer or the like.

What is claimed is:

1. A projection display device, comprising:
a main body cabinet;
an imager portion which is arranged in a position closer to one side surface of the main body cabinet to modulate light from a light source and guide the light in a direction away from the side surface; and
a projection portion which enlarges and projects the light modulated by the imager portion, wherein
the projection portion is formed by a projection lens portion into which the light from the imager portion is entered and a mirror portion which reflects the light having passed through the projection lens portion and lets the light travel toward a projection plane, the mirror portion being disposed so as to be shifted from an optical axis of the projection lens portion in a direction opposite to a direction in which the incident light from the projection lens portion is turned back, and
a control circuit portion and a metallic holding member are disposed within a space produced between the projection lens portion and the main body cabinet due to a position gap between the projection lens portion and the mirror portion, the holding member holding the control circuit portion therewithin while supporting the imager portion and the projection portion with respect to the main body cabinet.

2. The projection display device according to claim 1, wherein
the imager portion is provided with a heat sink for discharging heat generated at the imager portion.

3. The projection display device according to claim 1, wherein
an air supply portion for supplying air to the imager portion is disposed within the holding member.
